(19) United States
(12) Patent Application Publication
(10) Pub. No.: US 2012/0050462 A1
(43) Pub. Date: Mar. 1, 2012

(54) 3D DISPLAY CONTROL THROUGH AUX CHANNEL IN VIDEO DISPLAY DEVICES

(76) Inventors: Zhibing LIU, San Jose, CA (US); Jay Liang, Los Altos, CA (US)

(21) Appl. No.: 12/868,593

(22) Filed: Aug. 25, 2010

(51) Int. Cl. H04N 13/04

(52) U.S. Cl. 348/43; 348/E13.073

(57) ABSTRACT

A method to provide 3D video display includes the steps of receiving 3D information from the auxiliary channel corresponding to a frame; and providing the 3D information to a user accessory having stereoscopic capabilities so that the user accessory operate according to the 3D information when the frame is displayed. Further provided is a video system to provide 3D video displays including a receiver to receive the 3D information corresponding to a frame from the auxiliary channel in a transmission link, and to provide the 3D information to a user accessory as the frame is displayed. A 3D video display setup is also provided including a video system as above; a receiver having a display; and a clock to synchronize the display with a user accessory; and a user accessory having stereoscopic capabilities.

### BACKGROUND

1. Field of the Invention

The embodiments described herein relate to the field of 3D display video; and more particularly to the field of upgrading existing video transmitters supporting 2D video display to display 3D video.

2. Description of Related Art

Some video display transmitters may only support 2D video display. In order for these video display transmitters to provide support for 3D video display, new hardware may be needed. Furthermore, new circuitry may need to be fabricated for some video display transmitters supporting 2D video display so that they may support 3D video displays. Presently, a set of video display standards widely used in video transmitters and video data links is the VESA DisplayPort Standard (hereinafter, DPCD). Version 1.2 of Jan. 18, 2010 of the DP standard for video data links is incorporated herein by reference in its entirety.

Therefore, there is a need for an easy and smooth transition from a 2D video display to a 3D video display for devices supporting 2D video display.

### SUMMARY

In accordance with some embodiments of the present invention a method to provide 3D video display includes the steps of receiving 3D information from the auxiliary channel corresponding to a frame; and providing the 3D information to a user accessory having stereoscopic capabilities so that the user accessory operate according to the 3D information when the frame is displayed.

Further according to some embodiments of the present invention a video system to provide 3D video displays includes a receiver to receive the 3D information corresponding to a frame from the auxiliary channel in a transmission link, and to provide the 3D information to a user accessory having stereoscopic capabilities, as the frame is displayed.

Further, according to some embodiments of the present invention a 3D video display setup may include a video system including a receiver to receive the video data, having a display; and a clock to synchronize the display with a user accessory; and a user accessory having stereoscopic capabilities.

These and other embodiments of the present invention will be described in further detail below with reference to the following drawings.

### BRIEF DESCRIPTION OF THE DRAWINGS

FIG. 1 shows a 3D video display setup according to some embodiments of the present invention.

FIG. 2 shows a format for a transmission data link for a 3D display control through an AUX channel according to some embodiments of the present invention.

FIG. 3 shows a block diagram of a video link including a transmitter, a receiver, a display and a transmission link configured for a 3D display data transfer through an AUX channel, according to some embodiments of the present invention.

In the figures, elements having the same reference number have the same or similar functions.

### DETAILED DESCRIPTION

A 3D video display scheme is introduced to provide a transmission data link and a method for sending 3D related information through an auxiliary channel, according to some embodiments of the present invention. 3D related information may not be encoded in the main transmission data link in this approach, contrary to other 3D display configurations such as Main Stream Attribute (MSA). Thus, a transmitter device operating with a 2D display may easily and smoothly be upgraded to support a 3D display, according to the embodiments disclosed herein.

A transmission data link and a method are provided for sending 3D display information via an auxiliary channel so that an existing device supporting 2D video display may be upgraded to support a 3D video display. This method involves a receiver device intercepting AUX transactions from a transmitter device. The receiver device may decode the 3D information intercepted from the AUX transactions as specific 3D display information to control the video display. Some embodiments of the present invention may transmit frame based information for a main link channel, such as 3D left/right indicator, using an auxiliary channel. Further to using an auxiliary channel in the video transmission link, some embodiments may locally synchronize this information using a timing controller (ICON) circuit.

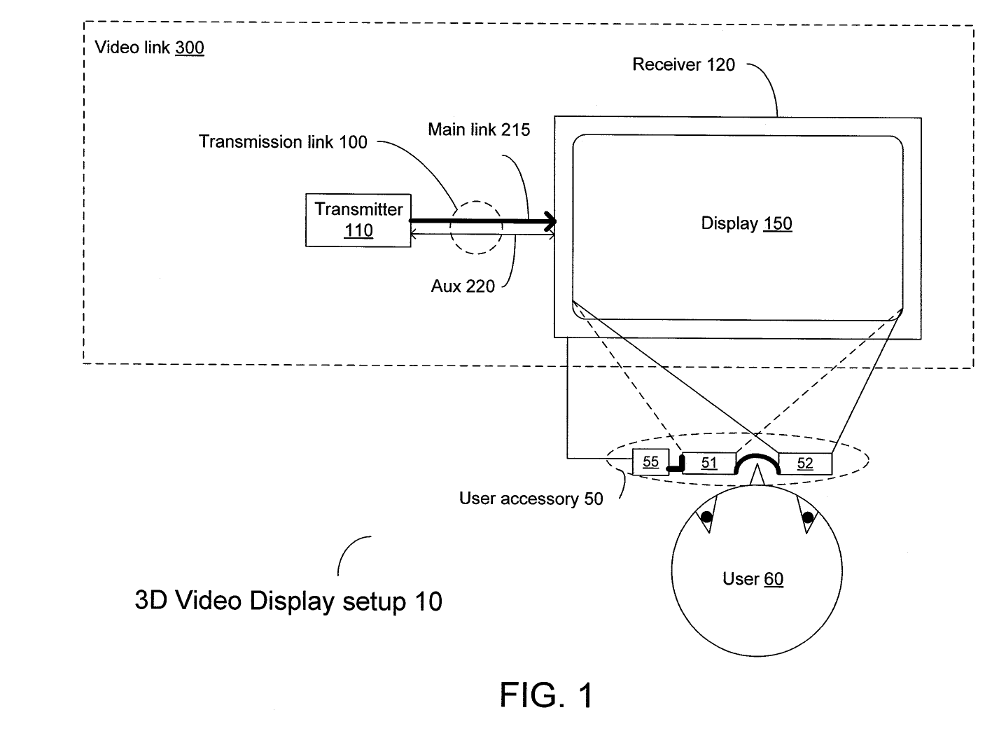

According to some embodiments of 3D video display, in addition to a 2D video information, a 3D frame indicator and frame type may be used. In some embodiments of the present invention, the 3D indicator and frame type may indicate that the current frame is for ‘left’ eye or ‘right’ eye, according to a 3D video display setup (cf. FIG. 1 below). For example, the DPCD standard defines main stream attribute ‘Misc1’ register bit ‘1’ and bit ‘2’ as encoding bits of 3D frames, namely:
00—not stereo 3D video
01—3D frame for right eye
11—3D frame for left eye
10—reserved.

The 3D-display information may be used by the receiver display and a user accessory such as a pair of glasses with a differential display for left and right eyes. Synchronization between the display device and the user accessory may allow the user to see a 3D image. In some embodiments of the present invention, while the 2D image corresponding to the ‘left’ eye is displayed, the glass for the ‘right’ eye may be turned ‘off’ in the user accessory. Likewise, while the 2D image corresponding to the ‘right’ eye is displayed, the glass for the ‘left’ eye is turned ‘off’ in the user accessory.

Using the main link in a video transmission line to transfer 3D display information involves a transmitter device and a display device specially configured to decode the 3D info. However, data in the main link may be transferred at rates greater than 1 GHz. Thus, new circuit architecture may be used to build a decoder and a synchronization loop so that 3D-display information is transmitted and received appropriately.

Some embodiments of the present invention use the auxiliary channel in a video transmission link to transmit 3D-related information. For example, a video transmitter may write the 3D related information in a reserved register. For example, register 0x00FFF may be used in the embodiments supported by the DPCD protocol. This AUX transaction may be intercepted by the receiver and a write register value may be temporarily buffered. The receiver then starts waiting for a vertical blanking period, and the write register value may be updated to display control signal generation when certain pre-defined vertical blanking point is reached.

FIG. 1 shows 3D video display setup 10 according to some embodiments of the present invention. Setup 10 may include video link system 300, and user accessory 50 to provide 3D video to user 60. In some embodiments of the present invention, user accessory 50 may include a ‘left’ viewing element 51 coupling the image displayed by display 150 to the left eye of user 60. Also included in accessory 50 may be ‘right’ viewing element 52, coupling the image displayed by display 150 to the right eye of user 60. In some embodiments, viewing elements 51 and 52 may be turned ‘on’ and ‘off’ in order to allow optical rays to pass through them (‘on’ state) or not (‘off’ state). According to some embodiments of the present invention, accessory 50 may be an active device controlled by controller 55. In some embodiments of the present invention, controller 55 may operate accessory 50 such that when ‘left’ viewing element 51 is ‘on’, ‘right’ viewing element 52 is ‘off’. Likewise, controller 55 may operate accessory 50 such that when ‘right’ viewing element 52 is ‘on’, ‘left’ viewing element 51 is ‘off’. The signal to operate controller 55 in accessory 50 may be provided by receiver 120, included in video link 300, according to some embodiments of the present invention.

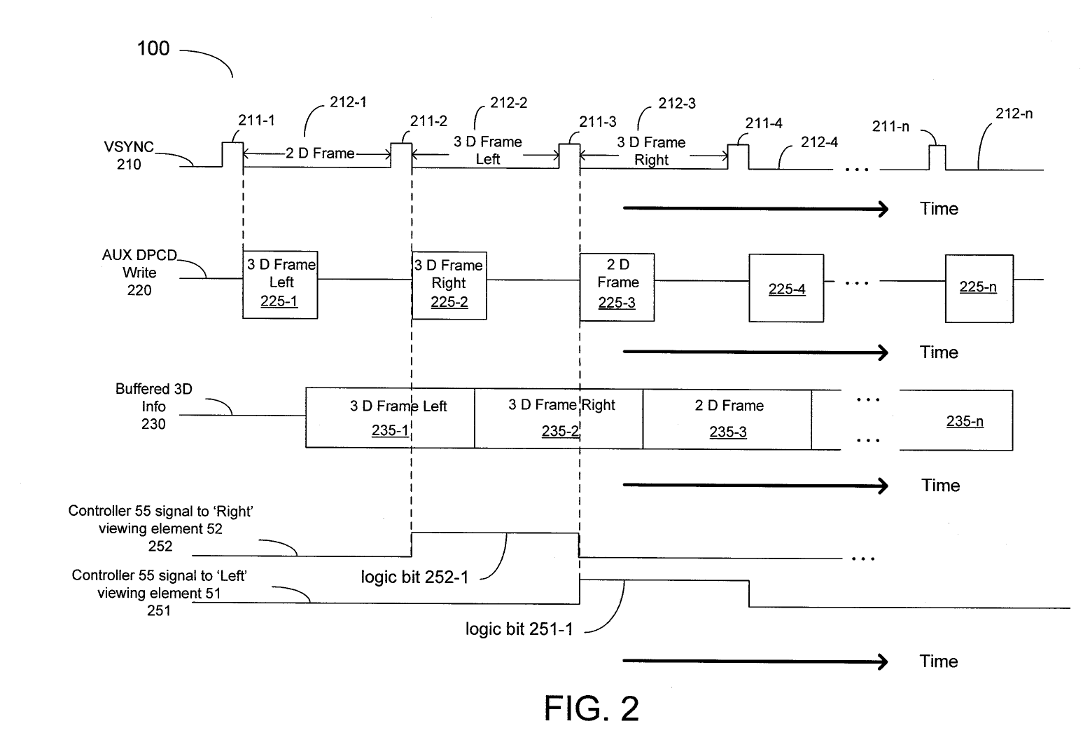

Video link 300 may include transmitter 110, transmission link 100, and receiver 120, according to some embodiments of the present invention. Receiver 120 may include display 150 to provide a video image. Transmission link 100 may include a main link 215 and an auxiliary (aux) channel 220 (cf. FIG. 2, below).

In some embodiments of 3D video display setup 10, transmitter 110 may be a computer processor executing a video-related operation. Some examples of such video-related operation may be a video-game with computer generated images. Some other examples of video-related operations may include a video feed that may be downloaded from a network by a computer. Some embodiments may include video data stored in a computer readable medium such as a CD, DVD, or Blu-ray disc.

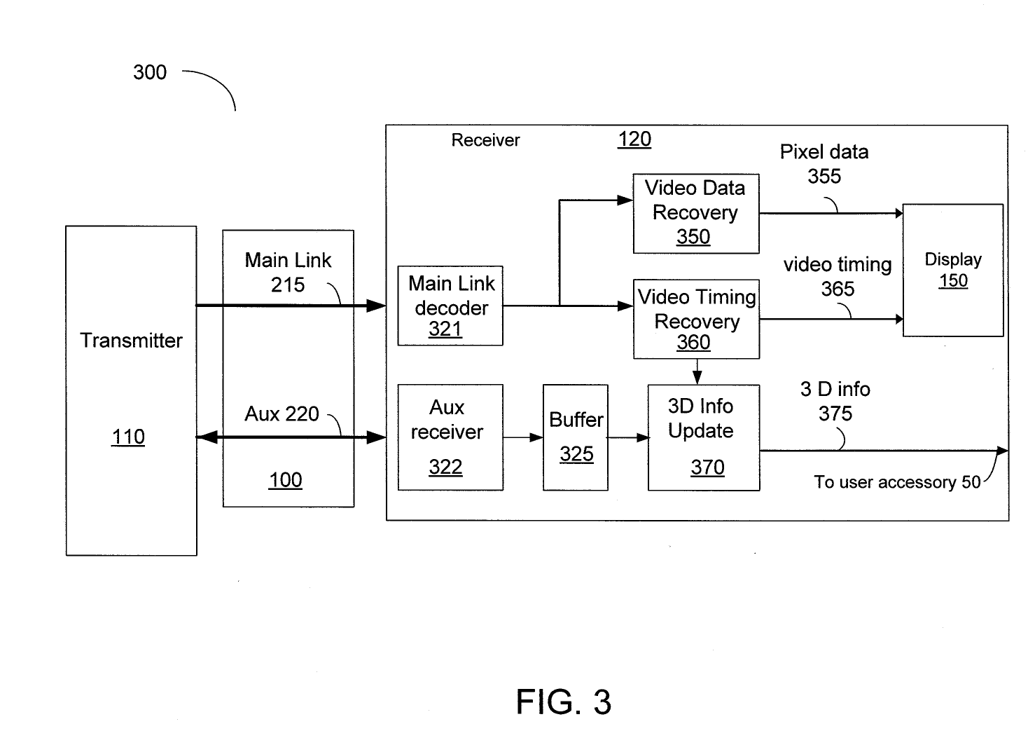

FIG. 2 shows a format for data transmission link 100 used for a 3D display control through AUX channel 220, according to some embodiments of the present invention. A train of vertical synchronization (vsync) pulses 211-1 to 211-n is provided by vsync channel 210. In some embodiments, pulses 211-1 to 211-n in vsync channel 210 may be provided to display 150 by a timing recovery circuit such as circuit 360 of FIG. 3. Aux channel 220 provides 3D frame information in strings 225-1 to 225-n. As mentioned above, in some embodiments of the present invention consistent with the DPCD standard, 3D information may include a two-bit string: ‘00’ for not stereo 3D video (2D frame), ‘01’ for a 3D ‘Right’ frame, and ‘11’ for a 3D ‘Left’ frame. In some embodiments of the present invention, strings 225-1 to 225-n may be received by auxiliary receiver 322 in receiver 120 (cf. FIG. 3 below).

Aux channel 220 may be a bi-directional communication channel between transmitter 110 and receiver 120, according to some embodiments of the present invention. In this manner, AUX channel 220 may implement a flexible delivery of control and status information between transmitter 110 and receiver 120. In some embodiments of the present invention, such as those supported by the DPCD standard, AUX channel 220 may be a half-duplex bi-directional channel, providing data communication in both directions, one direction at a time (not simultaneously), with transmitter 110 being the master and receiver 120 the slave (cf. FIG. 3 below). Buffered information 230 contains the same 3D information as provided by aux channel 220, but with a certain delay in time, as illustrated by bit strings 235-1 to 235-n in FIG. 2. The time delay introduced in bit strings 235-1 to 235-n in relation to bit strings 225-1 to 225-n may be obtained by storing bit strings 225-1 to 225-n in buffer 325, as illustrated in FIG. 3 below. In some embodiments of the present invention, receiver 120 may provide control signal 251 and 252 to viewing element 52. For example, control signal 252 may be synchronized to vsync signal 211-2 so that ‘Right’ viewing element 52 is turned ‘off’ while logic bit 252-1 is ‘high’. Thus, a 3D ‘Left’ frame may be viewed by user 60 during time interval 212-2. Likewise, control signal 251 may be synchronized to vsync signal 211-3 so that ‘Left’ viewing element 51 is turned ‘off’ while logic bit 251-1 is ‘high’. Thus, a 3D ‘Right’ frame may be viewed by user 60 during time interval 212-3. Furthermore, if a bit string contains a 2D frame indicator (e.g. ‘00’ according to some embodiments of the present invention), such as 235-3, then control signals 251 and 252 may be turned to ‘low’. Thus ‘Left’ viewing element 51 and ‘Right’ viewing element 52 may be turned ‘on’ during a 2D-frame period such as 212-4, allowing user 60 to view a 2D frame with both eyes.

According to the embodiment depicted in FIG. 2, a 3D information bit string related to a frame is provided to a buffer at the beginning of the active period of the previous frame. For example, bit string 225-1 for a ‘Left’ frame may be provided to buffer 325 (cf. FIG. 3 below) at the beginning of 2D frame 212-1, which is the frame displayed prior to 3D ‘Left’ frame 212-2. Likewise, bit string 225-2 for a ‘Right’ frame may be provided to buffer 325 at the beginning of 3D ‘Left’ frame 212-2.

According to some embodiments of the present invention, as depicted in FIG. 2, control signals 251 and 252 may be provided by receiver 120 to controller 55 in user accessory 50 once a pre-defined vertical blanking point is reached by display 150. In some embodiments of the present invention, this point may be such that it gives enough time to the physical mechanism of accessory 50 to produce the desired physical state for viewing elements 51 and 52. Furthermore, according to the embodiment depicted in FIG. 2, the predetermined vertical blanking point is selected by using a clock in receiver 120. In some embodiments, 3D info update block 370 (cf. FIG. 3) may verify the buffered bit string in buffer 325, to be able to provide a logic bit 252-1 for a ‘Left’ frame, or logic bit 251-1 for a ‘Right’ frame, according to the value contained in buffer 325. For example, during vsync pulse 211-2 update block 370 may find 3D frame ‘Left’ bit string 235-1 in buffer 325, and thus update control signal 252 to controller 55 by sending logic bit 252-1. Likewise, during vsync pulse 211-3 update block 370 may find 3D frame ‘Right’ bit string 235-2 in buffer 325, and thus update control signal 251 to controller 55 by sending logic bit 251-1.

According to the embodiment depicted in FIG. 2, bit string 225-1 for a ‘left’ frame is shown consecutively to bit string 225-2 for a ‘right’ frame. Some embodiments of the present invention may include 3D video displays where two, three, or more consecutive bit strings 225-1, 225-2, 225-3, are related to a ‘Left’ frame. In such cases, two, three, or more consecutive bit strings may be related to a ‘Right’ frame, subsequent to the bit strings related to the ‘Left’ frame. The number of consecutive bit strings corresponding to either a ‘Left’ or a ‘Right’ frame may depend on the specific application of video link 300, and on the technical specifications of user accessory 50 (cf. FIG. 1). In some embodiments, user accessory 50 may be limited by the speed at which viewing elements 51 and 52 may be turned ‘on’ and ‘off’. Thus, using a plurality of consecutive 2D frames related to a specific frame type (e.g. ‘Left’ or ‘Right’) may allow user accessory 50 to perform a switching operation or some other physical operation, according to some embodiments of the present invention.

FIG. 3 shows a block diagram of video link 300 including transmitter 110 and receiver 120 configured for a 3D display data transfer through AUX channel 220. Also shown in FIG. 3 is display 150 according to some embodiments of the present invention. Data transmission link 100 may include main link 215 for video data transfer, and auxiliary channel 220. Link 215 contains pixel information for the video display, configured according to a protocol. For example, some of the pixel information transferred in channel 215 may be variable color depths, refresh rates, and display pixel formats. Some embodiments of the present invention may use the DPCD standard to configure the video data transferred in main link 215. Link 215 may include multiple lanes for data transfer, according to some embodiments of the present invention. For example, link 215 may include a single lane, two lanes, or up to four lanes, according to embodiments disclosed in the DPCD standard. According to some embodiments of the present invention supported by the DPCD standard, each lane may include a doubly terminated differential pair, which enables high bandwidth data transfer.

Some embodiments of the present invention, such as those supported by the DPCD standard, may provide AUX channel 220 having a 1 Mbps (mega bit per second) transmission rate, with a maximum latency of 500 micro-seconds. In some examples, this transmission rate may be lower than that of main link 215. For example, in some embodiments such as those supported by the DPCD standard, main link 215 may be a high-bandwidth, low-latency channel used to transport isochronous data streams. For example, some embodiments of the present invention may provide video channel 215 having a transmission rate of 2.7 Gbps (giga bit per second) or 1.62 Gbps per lane. According to some embodiments of the present invention, AUX channel 220 may include an ac-coupled, doubly terminated differential pair. Data transmitted in AUX channel 220 may be encoded using Manchester II coding, according to some embodiments such as supported by the DPCD standard. In some embodiments, the clock signal in AUX channel 220 may be extracted from the data stream itself, for example when using Manchester II coding.

In some embodiments of the present invention such as depicted in FIG. 3, receiver 120 may include main link decoder 321 to receive pixel data transmitted through link 215. Decoder 321 may extract the clock signal from the data packets in link 215 and may provide the clock to timing recovery block 360, according to some embodiments of the present invention. Furthermore, decoder 321 may provide pixel information extracted from link 215 to data recovery block 350. Block 350 checks and corrects any error in the pixel data. In some embodiments, block 350 may use a plurality of check redundancy circuits (CRCs) to verify the status of the pixel information. Block 350 provides corrected pixel data 355 to display 150 in receiver 120. In some embodiments of the present invention, corrected pixel data 355 may be provided to a plurality of display devices along a data transmission link. Timing recovery block 360 may correct any distortions in the clock signal embedded in the video data from link 215, according to some embodiments of the present invention. Such distortions may arise from losses and capacitive load in transmission link 100, and accumulated jitter from transmitter 110 and decoder 321. Block 360 obtains a corrected clock signal and provides a video timing signal 365 to display 150 in receiver 120. In some embodiments of the present invention, video timing signal 365 may be provided to a plurality of display devices along a data transmission link. In some embodiments of the present invention, vsync 210 may be included as part of the video timing signal 365 provided by block 360. According to some embodiments of the present invention, timing recovery block 360 may also provide video timing signal 365 to 3D update block 370, which provides 3D information 375 to controller 55, as will be described in detail below.

According to some embodiments of the present invention as depicted in FIG. 3, receiver 120 may further include auxiliary receiver block 322. Block 322 may include circuit components such as phase locked loops (PLLs) and differential signal amplifiers in order to receive data from AUX channel 220 and provide auxiliary data to buffer 325. According to some embodiments of the present invention, the auxiliary data may include 3D information such as described in relation with FIG. 2 above. For example, in some embodiments of the present invention, bit string 225-1 in AUX channel 220 may indicate that the video data packet corresponding to time slot 212-2 is a ‘Left’ frame in a stereoscopic 3D image configuration (cf. FIG. 2). Likewise, bit string 225-2 in AUX channel 220 may indicate that the video data packet corresponding to time slot 212-3 is a ‘Right’ frame in a 3D display configuration (cf. FIG. 2), according to some embodiments. In some embodiments buffer 325 may store the 3D information provided by AUX channel 220 while each frame is being actively displayed. For example, bit string 235-1 in buffered string 230 (cf. FIG. 2) may include bit string 225-1, relating to a ‘Left’ frame for a 3D display configuration. Likewise, bit string 235-2 in buffered string 230 may include bit string 225-2, relating to a ‘Right’ frame for a 3D display configuration.

According to some embodiments of the present invention depicted in FIG. 3, transmitter 110 may send 3D related information through channel 220 prior to the frame currently on display in receiver 120. This is due to the lower transmission rate of AUX channel 220 compared to main link 215, according to some embodiments discussed above. Transmitter 110 may send 3D info at the beginning of the active period of previous frame, so that receiver 120 may timely buffer the 3D info in block 325 and wait for a predetermined vertical blanking period in a vsync pulse 211-1 to 211-n (cf. FIG. 2). According to some embodiments of the present invention, vsync pulses 211-1 to 211-n may be provided by block 360 to block 370. Block 370 may further provide updated 3D info 375 to controller 55 in user accessory 50, or to a plurality of display devices along a data transmission link.

In some embodiments of the present invention supporting DPCD standards, receiver 120 may decode reserved DPCD address space. Thus, receiver 120 may intercept 3D information into buffer string 230 and store it in buffer 325 until a predetermined vertical blanking period is reached during a vsync pulse 211-1 to 211-n (cf. FIG. 2).

Embodiments of the invention described above are exemplary only. One skilled in the art may recognize various alternative embodiments from those specifically disclosed. Those alternative embodiments are also intended to be within the scope of this disclosure. As such, the invention is limited only by the following claims.

What is claimed is:

1. A method to provide 3D video display comprising the steps of:
receiving 3D information from the auxiliary channel corresponding to a frame; and
providing the 3D information to a user accessory having stereoscopic capabilities so that the user accessory operate according to the 3D information when the frame is displayed.

2. The method of claim 1 wherein:
receiving the 3D information from the auxiliary channel corresponding to a frame further comprises the steps of:
writing the 3D information in a buffer;
updating the 3D information when a blanking point is reached by the display; and
synchronizing the 3D information with a clock signal.

3. The method of claim 1 wherein:
the frame can be a 3D ‘Left’ frame or a 3D ‘Right’ frame; and wherein
stereoscopic capabilities include the control of a left and a right viewing element in the user accessory;
the left viewing element is ‘on’ while a 3D frame is a ‘Left’ frame; and
the right viewing element is ‘on’ while a 3D frame is a ‘Right’ frame.

4. The method of claim 3, further wherein the 3D information comprises a bit string indicating if a 3D frame is a ‘Left’ frame, and a bit string indicating if a 3D frame is a ‘Right’ frame.

5. The method of claim 2, further wherein synchronizing the 3D information with a clock signal in the receiver comprises synchronizing the clock signal in the receiver with providing the 3D information to the user accessory.

6. A video system to provide 3D video displays comprising:
a receiver to receive the 3D information corresponding to a frame from the auxiliary channel in a transmission link, and to provide the 3D information to a user accessory having stereoscopic capabilities, as the frame is displayed.

7. The video system of claim 6 wherein the receiver comprises a clock to synchronize the display and the user accessory.

8. The video system of claim 6 wherein the receiver further comprises a display and buffers the 3D info and waits for the display to reach a blanking point to provide 3D information to the user accessory having stereoscopic capabilities.

8. The video system of claim 8, wherein the receiver further comprises a decoder, a buffer, and a synchronizer to provide pixel data, clock data, and 3D data to the display and to the user accessory having stereoscopic capabilities.

9. A 3D video display setup comprising:
a video system further comprising:
a receiver to receive the video data, having a display; and
a clock to synchronize the display with a user accessory; and
a user accessory having stereoscopic capabilities.

10. The 3D video display setup of claim 9 wherein the user accessory comprises a controller, a left viewing element, and a right viewing element; and
the controller in the user accessory receives a control signal from the receiver.

11. The 3D video display setup of claim 9, further wherein the user accessory receives the 3D information from the receiver to control the left viewing element and the right viewing element.
